(19) United States
(12) Patent Application Publication
(10) Pub. No.: US 2012/0076331 A1
(43) Pub. Date: Mar. 29, 2012

(54) METHOD FOR RECONSTRUCTING A SPEECH SIGNAL AND HEARING DEVICE

(75) Inventors: Ulrich Giese, Furth (DE); Alexander Grafenberg, Effeltrich (DE)

(73) Assignee: SIEMENS MEDICAL INSTRUMENTS PTE. LTD., SINGAPORE (SG)

(21) Appl. No.: 13/245,993

(22) Filed: Sep. 27, 2011

(30) Foreign Application Priority Data
Sep. 27, 2010 (DE) 10 2010 041 435.2

(51) Int. Cl. H04R 25/00; G10L 21/00

(52) U.S. Cl. 381/312; 704/270; 704/E11.001

(57) ABSTRACT

Speech intelligibility is to be improved in hearing devices and in particular in hearing aids. A method for reconstructing a speech signal is therefore proposed, wherein a predefined amplitude spectrum of a speech component is stored. The amplitude spectrum of an input signal containing the speech signal is acquired. At least one matching portion and one non-matching portion of the predefined amplitude spectrum with respect to the amplitude spectrum of the input signal is detected. Finally the gain of the input signal in the non-matching portion of the amplitude spectrum is varied such that a closer match with the predefined amplitude spectrum is achieved compared to the original gain.

### CROSS-REFERENCE TO RELATED APPLICATION

This application claims the priority, under 35 U.S.C. §119, of German application DE 10 2010 041 435.2, filed Sep. 27, 2010; the prior application is herewith incorporated by reference in its entirety.

### BACKGROUND OF THE INVENTION

### Field of the Invention

The present invention relates to a method for reconstructing a speech signal. The present invention additionally relates to a hearing device with which a speech signal can be reconstructed. The term “hearing device” is here taken to mean any sound-emitting device worn on or in the ear, in particular a hearing aid, headset, earphones and the like.

Hearing aids are portable hearing devices for use by the hard of hearing. In order to meet the numerous individual requirements, different hearing aids types are available, such as behind-the-ear (BTE) hearing aids, a hearing aid with an external receiver (RIC: receiver in the canal) and in-the-ear (ITE) hearing aids, e.g. concha or completely-in-canal (CIC) devices. The hearing instruments listed by way of example are worn on the outer ear or in the auditory canal. However, bone conduction hearing aids, implantable or vibrotactile hearing aids are also commercially available. In these cases, the damaged hearing is stimulated either mechanically or electrically.

The basic components of a hearing aid are an input transducer, an amplifier and an output transducer. The input transducer is generally a sound pickup device, e.g. a microphone, and/or an electromagnetic pickup such as an induction coil. The output transducer is mainly implemented as an electroacoustic transducer, e.g. a miniature loudspeaker, or as an electromechanical transducer such as a bone conduction receiver. The amplifier is usually incorporated in a signal processing unit. The basic configuration is shown in FIG. 1 using the example of a behind-the-ear hearing aid. Installed in a hearing aid housing 1 for wearing behind the ear are one or more microphones 2 for picking up sound from the environment. A signal processing unit 3 which is likewise incorporated in the hearing aid housing 1 processes the microphone signals and amplifies them. The output signal of the signal processing unit 3 is transmitted to a loudspeaker or receiver 4 which outputs an audible signal. The sound is in some cases transmitted to the wearer's eardrum via a sound tube which is fixed in the auditory canal using an ear mold. The hearing aid and in particular the signal processing unit 3 are powered by a battery 5 likewise incorporated in the hearing aid housing 1.

An aspect for providing hearing impaired people with hearing aids is speech intelligibility. This means that a word or word component must be recognized as such by the hearing aid wearer. A crucial role in speech intelligibility is played by the consonants, particularly by the “S”, for example. In the “speech in a noisy environment” listening situation, consonants are often not clearly audible or are heard as different consonants. So for example, the word “Sight” may be heard as “Fight”.

To improve speech intelligibility, noise reduction algorithms or speech amplification algorithms are mainly used. In the “speech in broadband noise” listening situation, only a directional microphone increases speech intelligibility. However, directional microphones are only of practical use when the noise and speech are coming from different directions. Other noise suppression algorithms, e.g. Wiener filters, do not increase speech intelligibility in noise. At best, they reduce the listening effort required.

### SUMMARY OF THE INVENTION

It is accordingly an object of the invention to provide a method for reconstructing a speech signal and a hearing device which overcome the above-mentioned disadvantages of the prior art methods and devices of this general type, with which increased speech intelligibility can be ensured.

This object is achieved according to the invention by a method for reconstructing a speech signal by storing a predefined amplitude spectrum of a speech component, acquiring an amplitude spectrum of an input signal containing the speech signal, detecting at least one portion of the predefined amplitude spectrum matching the amplitude spectrum of the input signal and one portion thereof not matching the amplitude spectrum of the input signal, and varying an input signal gain in the non-matching portion of the amplitude spectrum such that a closer match with the predefined amplitude spectrum is achieved compared to the original gain.

Additionally provided according to the invention is a hearing device with which a speech signal can be reconstructed. The hearing device contains a storage device for storing a predefined amplitude spectrum of a speech component, an acquisition device for acquiring an amplitude spectrum of an input signal containing the speech signal, a detection device for detecting at least one portion of the predefined amplitude spectrum matching the amplitude spectrum of the input signal and one portion thereof not matching the amplitude spectrum of the input signal, and an amplification device with which a speech signal gain in the non-matching portion of the amplitude spectrum can be varied such that a closer match with the predefined amplitude spectrum is achieved compared to the original gain.

The input signal containing the speech signal and any interfering noise is advantageously examined for predefined patterns in the amplitude spectrum. If particular patterns or parts thereof are detected in the amplitude spectrum of the input signal, the rest of the amplitude spectrum can be adapted to the predefined pattern by varying the gain. This means that, for example, a predefined speech component can be “worked out” from an amplitude spectrum.

The input signal is preferably processed in a plurality of frequency channels, and each amplitude spectrum is characterized by one amplitude value per frequency channel. This is equivalent to signal processing in digital frequency values and assigning an amplitude value to each frequency value in a particular amplitude spectrum.

It is particularly advantageous if the speech component is a consonant. Consonants are more important than vowels in terms of speech intelligibility.

In another embodiment, a predefined amplitude spectrum of a plurality of speech components is stored, the amplitude spectrum of the input signal is checked in respect of an at least partial match with each of the predefined amplitude spectra, and the gain is varied as a function of the at least partially matching predefined amplitude spectrum. This enables, for example, a plurality of different consonants in an input signal to be selectively reconstructed if corresponding portions of amplitude spectra are detected.

Detection in respect of matches can be limited to formants. Formants are rapidly detectable in a spectrum and carry the essential information for the distinguishability of speech components.

In another embodiment, the gain can be varied such that a complete match with the predefined amplitude spectrum is achieved, thereby enabling particular speech components to be made very clearly audible.

The detection of at least one portion of the predefined amplitude spectrum matching the amplitude spectrum of the input signal and one portion thereof not matching the amplitude spectrum of the input signal can include aligning the absolute values of the predefined amplitude spectrum with the absolute values of the amplitude spectrum of the input signal. It is therefore not necessary for the amplitude spectrum of the input signal to match the stored amplitude spectrum absolutely. Rather, relative matching of the spectral values will also suffice.

In addition, after varying of the gain, the input signal as a whole can be additionally amplified or transferred to another frequency range, thereby enabling the audibility of the reconstructed speech component to be further increased.

Particularly advantageously, the inventive method for reconstructing a speech signal can be used for signal processing in a hearing aid.

Other features which are considered as characteristic for the invention are set forth in the appended claims.

Although the invention is illustrated and described herein as embodied in a method for reconstructing a speech signal and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a basic design of a hearing aid according to the prior art;

FIG. 2 is a diagram showing a schematic time signal of a consonant;

FIG. 3 is a diagram showing a spectrum of the time signal from FIG. 2;

FIG. 4 is a diagram showing a detection and reconstruction of a spectrum in a first exemplary embodiment; and

FIG. 5 is a diagram showing the detection and reconstruction of a spectrum in a second exemplary embodiment.

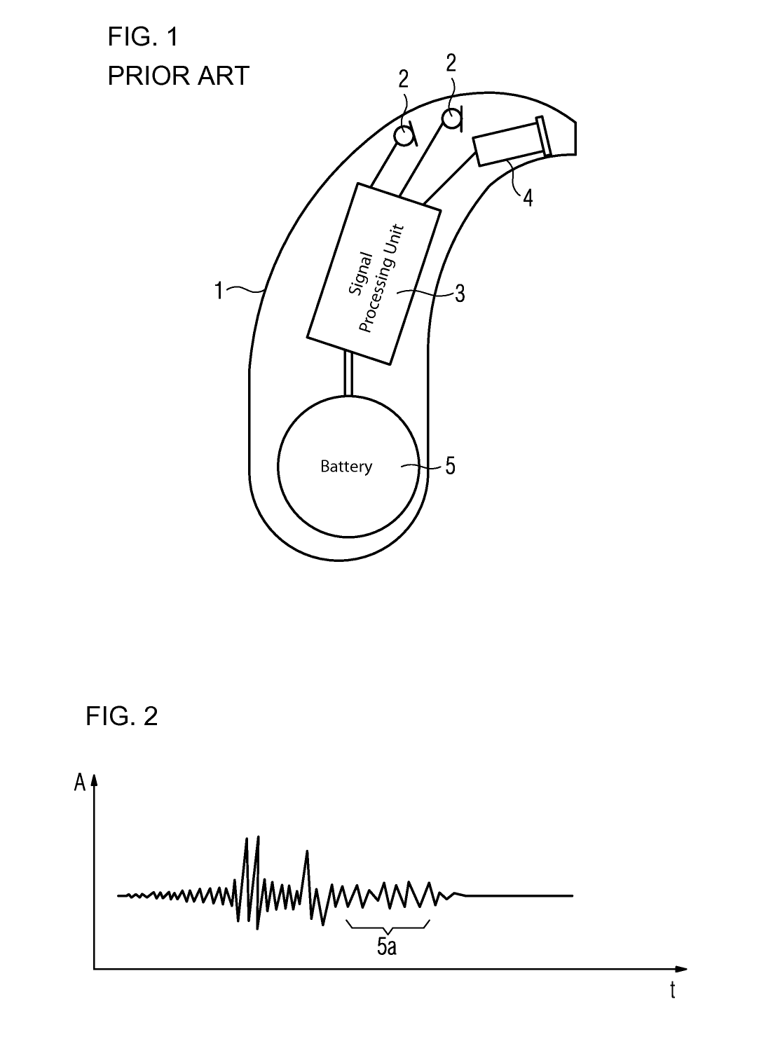

### DETAILED DESCRIPTION OF THE INVENTION

The exemplary embodiments described below constitute preferred embodiments of the present invention.

When a consonant is spoken, a corresponding time signal can be obtained, as is symbolically illustrated in FIG. 2. From the time signal, a sample or snapshot 5a with a particular width in time can be obtained.

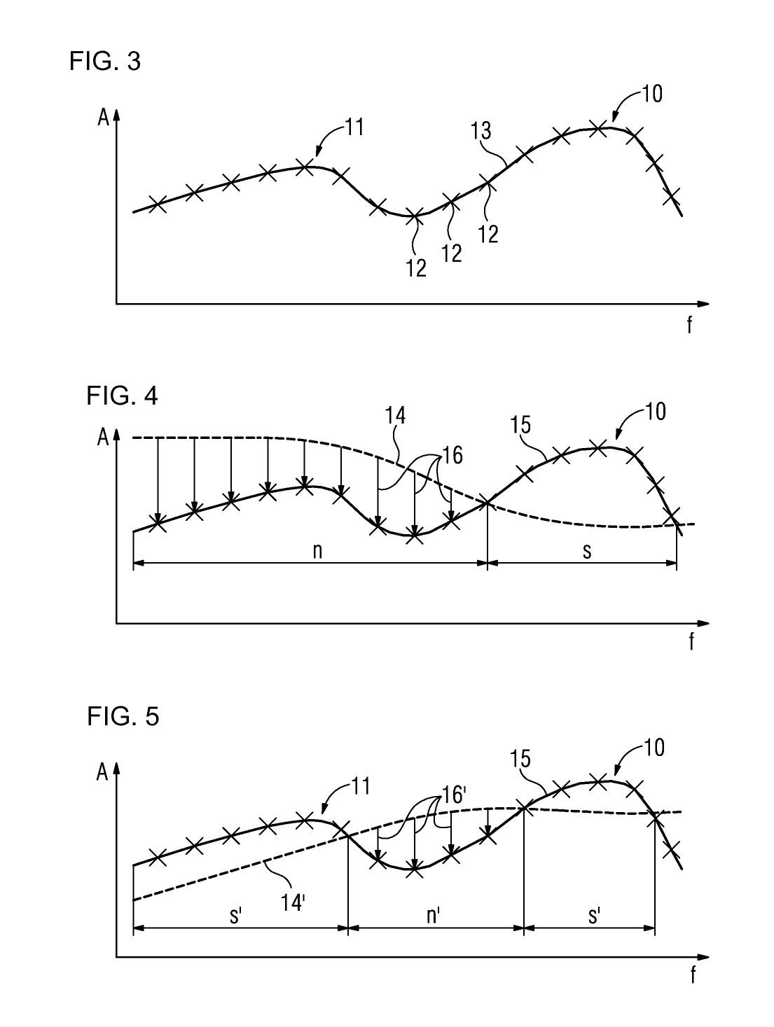

From the time snapshot 5a, a short-term spectrum can usually be obtained, as shown by way of example in FIG. 3. The short-term spectrum of a consonant possesses a typical shape. In particular, a consonant can be identified from the specific positions of its formants 10, 11.

To carry out the method according to the invention or to implement the hearing device according to the invention, one or more consonants are now recorded in a noise-free environment. The spectrum of each consonant is, for example, digitally sampled and the individual sample values 12 of the short-term spectrum 13 are stored in a storage device of the hearing device, in particular of a hearing aid. In this way a short-term spectrum can be stored in the hearing device for each consonant recorded.

During operation, the hearing device continuously analyzes the input signal and looks for the spectral pattern of the consonant or the patterns of the stored consonants. Normally the consonant (the method will be described hereinafter with reference to a single consonant) is then spoken against background noise. In the exemplary embodiment in FIG. 4, the background noise has the noise spectrum 14, whereas the consonant, i.e. the wanted signal, possesses the spectrum 15. In a section n of the spectrum, the noise spectrum 14 predominates, whereas in another section s, the signal spectrum 15, namely that of the spoken consonant, predominates. In the region s, it is actually the consonant spectrum 15 that is sampled by the signal processing when the total spectrum is sampled. The sampled spectrum 15 is compared with the stored spectrum 13. If this portion of the spectrum 15 possesses e.g. a very characteristic shape, it can be inferred therefrom that the stored consonant was spoken. It is then assumed that the signal is overlaid with noise in the spectral region n. The gain is then reduced e.g. channel by channel so that the stored spectrum 13 of the consonant also obtains in the spectral region n. This gain reduction is symbolized by the arrows 16 in FIG. 4. The spectrum is therefore reconstructed in the region n or rather extrapolated on the basis of the measured consonant spectrum 15 with the aid of the stored spectrum 13. The resulting spectrum corresponds to that of the stored spectrum which was recorded without background noise. If the reconstructed spectrum is now reproduced for the hearing aid wearer, he will hear the spoken consonant more clearly, as the background noise has been attenuated. He will hear the consonant virtually as if it were spoken in silence.

In the example in FIG. 4, only a very small portion of the short-term spectrum (region s) is detected as the prominent region. Whether this small region alone suffices to identify the relevant consonant depends on the performance of the detection device in the hearing instrument. As a rule, a single peak, i.e. formant 10, will not suffice to identify a consonant properly. In FIG. 5, a second exemplary embodiment shall therefore be explained in which identification can be performed more easily. The same consonant spectrum 15 is here overlaid with a noise spectrum 14′ of lesser amplitude. Noise predominates only in a very small region n′. In the much larger region s′ the consonant spectrum 15 predominates. In particular, the formants 10 and 11 extend above the noise spectrum 14′. On the basis of the formants 10, 11 and possibly also on the basis of the spectral curves in the regions s′, the spoken constant can be more easily identified by comparison with the stored spectrum 13 than in the case of FIG. 4. To reconstruct the entire spectrum, only the gain in the region n′ also needs to be reduced in accordance with the arrows 16′. The reconstructed spectrum then also no longer has noise components. The hearing aid wearer then perceives the spoken consonant as if it were spoken in silence.

The reconstructed consonants can then undergo further processing, e.g. by specific amplification. Likewise the reconstructed consonants can for example be shifted by frequency translation/compression into a region that is audible to the hearing aid wearer.

Although the above examples relate only to consonants, the method can also be applied to other speech components such as entire words or logatomes.

Similarly to reducing the noise components, the wanted signal components of the speech component can be increased in the sense of higher gain. The entire spectrum is then, for example, increased uniformly in the regions s′, whereas in the region n′ it is increased on a channel-specific basis only to the extent that eventually the pattern of the stored spectrum 13 is produced.

The present invention advantageously enables a spectral pattern of a speech component to be detected in background noise using statistical methods. The noise-affected pattern is then reconstructed on the basis of a known pattern by specific reduction of the gain (in the relevant channels). The reconstructed speech component can then be further processed. Altogether the respective speech component is subject to noise suppression, thereby enabling increased speech intelligibility in noise situations to be achieved.

1. A method for reconstructing a speech signal, which comprises the steps of:
storing a predefined amplitude spectrum of a speech component;
acquiring an amplitude spectrum of an input signal containing the speech signal;
detecting at least one matching portion and one non-matching portion of the predefined amplitude spectrum with respect to the amplitude spectrum of the input signal; and
varying a gain of the input signal in the non-matching portion of the amplitude spectrum such that a closer match with the predefined amplitude spectrum is achieved compared to an original gain.

2. The method according to claim 1, which further comprises processing the input signal in a plurality of frequency channels, and each amplitude spectrum is characterized by one amplitude value per frequency channel.

3. The method according to claim 1, wherein the speech component is a consonant.

4. The method according to claim 1, which further comprises:
storing the predefined amplitude spectrum of a plurality of speech components; and
checking the amplitude spectrum of the input signal in respect of an at least partial match with each of the predefined amplitude spectra, and a gain is varied in dependence on an at least partially matching predefined amplitude spectrum.

5. The method according to claim 1, wherein detection in respect of matches is limited to formants.

6. The method according to claim 1, which further comprises varying the gain such that a complete match with the predefined amplitude spectrum is achieved.

7. The method according to claim 1, wherein detection includes aligning absolute values of the predefined amplitude spectrum with absolute values of the amplitude spectrum of the input signal.

8. The method according to claim 1, wherein, after the gain has been varied, the input signal is additionally amplified or transferred to another frequency range.

9. A method for processing a speech signal in a hearing aid, which comprises the steps of:
reconstructing the speech signal by the further steps of:
storing a predefined amplitude spectrum of a speech component;
acquiring an amplitude spectrum of an input signal containing the speech signal;
detecting at least one matching portion and one non-matching portion of the predefined amplitude spectrum with respect to the amplitude spectrum of the input signal; and
varying a gain of the input signal in the non-matching portion of the amplitude spectrum such that a closer match with the predefined amplitude spectrum is achieved compared to an original gain.

10. A hearing device with which a speech signal can be reconstructed, the hearing device comprising:
a storage device for storing a predefined amplitude spectrum of a speech component;
an acquisition device for acquiring an amplitude spectrum of an input signal containing the speech signal;
a detection device for detecting at least one matching portion and one non-matching portion of the predefined amplitude spectrum with respect to the amplitude spectrum of the input signal; and
an amplification device with which a gain of the speech signal in the non-matching portion of the amplitude spectrum can be varied such that a closer match with the predefined amplitude spectrum is achieved compared to an original gain.
